(19) United States
(12) Patent Application Publication
(10) Pub. No.: US 2002/0095369 A1
(43) Pub. Date: Jul. 18, 2002

(54) Anonymous auctioning of structured financial products over a computer network

(76) Inventors: Harry A. Kaplan, Brooklyn, NY (US); Patrick F. Downes, Greenwich, CT (US)

Correspondence Address: Brian P. Hopkins, Mintz, Levin, Cohn, Ferris,, Glovsky and Popeo, P.C., One Financial Center, Boston, MA, 02111, US

(21) Appl. No.: 10/043,899

(22) Filed: Jan. 11, 2002

Related U.S. Application Data
(60) Provisional application No. 60/261,502, filed on Jan. 12, 2001.

(51) Int. Cl. G06F 17/60

(52) U.S. Cl. 705/37

(57) ABSTRACT

A method and system for anonymously buying and selling a structured financial product over a computer network includes providing a host for receiving information for the offer for sale of a structured financial product from a first client, anonymously publishing the offer for sale of the structured financial product over a computer network by the host to a plurality of second clients over the computer network for a predetermined period of time, initiating the offer for sale of the product over the network at a prescribed starting time, providing an opportunity for the plurality of second clients to bid on the product in real-time during the period of time, automatically publishing to the plurality of second clients viewing the sale of the product each bid in real-time as each bid is submitted by one of the second clients, wherein a substantial number of all submitted bids are displayed together during the offer for sale, and awarding the structured financial product to a second client of the plurality of the second clients submitting the highest bid by the end of the predetermined period of time.

The present invention claims benefit under 35 U.S.C. § 119(e) of U.S. Provisional Patent Application No. 60/261,502, filed Jan. 12, 2001, the entire disclosure of which is herein incorporated by reference.

### FIELD OF THE INVENTION

The present invention relates to a computerized auction system and a method for carrying out an auction system where users access the auction system by remote terminals.

### BACKGROUND OF THE INVENTION

An auction is a method of selling goods through the process of competition. At an auction, buyers, who are referred to as bidder, make competitive bids for goods, and sellers designate goods, which are up for sale to the highest bidder. Sellers who conduct the process of bidding are referred to as auctioneers.

The important principle in auctioning is to allow buyers the initiative of determining the market price through mutual competition, rather than having the price set by the seller. When a seller determines the market price, he is quoting his opinion on the value of goods, and then possibly negotiating with the individual buyer. This is one of the reasons why the auction method has often been used traditionally for auctioning of scarce valuable items, whose exact market prices are difficult to determine. In recent years the techniques of auctioning have begun to become increasingly favorable for transactions on the Internet.

Auctions for sale of products have proven to be very popular and the success of the systems involve two major features. Typically with auction systems, there is the possibility to obtain the product at a very competitive price. In addition, there is the skill of the buyer who participates in the auction process and makes fast decisions whether to continue to participate or to recognize the price has become too high. The auction process, traditionally, has been a relatively fast process which changes quickly. The standard auction process involves users bidding for a particular product, and the product is sold to the highest bidder.

The dynamic nature of the auction process, in its traditional form, is attractive to a certain number of participants, but it is also an obstacle to a further group of participants who do not wish to rush their decision process. For this reason, there are other variations of the auction process where the time period for the auction is much longer and the feedback of information tends to be slower. Some auction processes do not provide any real time feedback, such as a silent auction process, where users merely submit their bid, which is confidential.

Examples of traditional auctions, performed for centuries, are described below.

1. The Ascending Order or an English Auction. The bidders quote successively higher prices in order to determine the best price for the goods. The goods are sold to the highest bidder. Thus, the order of the bids are ascending in terms of the price level.

The starting bid may be decided either by the auctioneer or by one of the potential buyers.

Many variations are possible on the English auction, e.g., providing fixed price advances for each bid, or providing minimums on each advance.

An example of an ascending auction is the Interval Auction. Here, the bidding must be conducted in a certain time interval. This time interval gives bidders reasonable time to consider their bids. For example, it may be pre decided that the auction will start at 3 p.m., and the final decision on the auction will be made at 3:30 p.m. This gives the buyers 30 minutes to ponder and to raise their bids before a final decision is made. The following are the tradeoffs in adjusting the time interval for an auction:

If the time-interval is too long, the auction is too slow and the rate of sales will slow down.

If the time-interval is too short, the bidders will not have sufficient time to bid against each other and sufficiently raise the price.

2. The Descending Auction or a Dutch Auction. A reverse auction where the price of the product decreases in a set manner during the time period of the auction and each participant is provided with the current price, the quantity on hand and the time remaining in the auction. This type of auction, typically, takes place over a very short period of time and there is a flurry of activity in the last portion of the auction process. The actual auction terminates when there is no more product to be sold or the time period expires; quoting a good initial price is critical to the success of the descending auction. If the initial price which is quoted is too high, then the auctioneer may spend too much time reciting bids which are not useful. If the initial bid price is too low, then the auctioneer may be unable to obtain the best price for the goods.

3. The Simultaneous Bidding or a Japanese Auction. All bids are made by prospective buyers at the same time. The highest bid is taken to be the price at which the goods are finally sold. This technique is often utilized for the sale of fish in Tokyo.

In simultaneous bidding, it is possible for one buyer to make multiple bids for a given item. For example, a bidder may provide the following three bids for a given item: $50, $20, and $10. If it turns out that the highest bid that any other buyer in the system has made is $18, then the bid for $20 may be awarded to the buyer. This kind of technique reduces the changes that a bidder may overpay because of the lack of knowledge about the bids made by other bidders.

Similarly, in a Haphazard Bidding system, the bidders are unaware of the exact nature of the bids made by others. An example of such a scheme is the written tender scheme in which bids are made in writing and posted to an auction official. The best bid is picked from among these. In a haphazard bidding systems, sometimes considerable temptation may exist for the seller to move the auction to its advantage, since the buyers are not aware of each other's bids.

The auction process for the sale of products has also been used on the Internet. In this case, the various users send E-mail to the auction site with details of their bid and identity. Details of the bid are posted on the auction site computer and are available to other participants. The auction process typically has a time period of several days or weeks, and the product is allocated to the highest bidders. This type of process does not provide the excitement or the real time dynamic feedback of a traditional auction or a reverse auction. One of the advantages of this system is the lack of complexity in running of the auction process over the Internet where E-mail is used to communicate with the auction computer.

The disclosed system may be implemented on any secure linking of market participants and the auction host, including intranets and virtual private networks.

While the implementation of electronic commerce facilities in auctions improves the depth of market participation and increases the speed at which transactions are consummated, existing methods are deficient for certain types of transactions and markets.

Arcane infrequently traded items such as antiques, rare art collectibles are illiquid and have limited external information for valuation purposes. They require careful appraisal on the part of each market participant before a transaction can occur. Similarly, certain financial instruments, while economically important, do not have a transparent and readily available source of pricing information. It is incumbent upon each buyer and seller to evaluate such financial products on their individual merits, as well as in light of changing economic conditions and prices of more liquid publicly traded securities. When such financial products must be quickly purchased or sold by a given market participant, it is traded in an illiquid market at a price that is often based on mere conjecture. Moreover, the marketplace for such products has developed into an aggregation of specialists in particular subsectors of the market for “structured” financial products, with disparate levels of information and resulting economic inefficiency. Consequently, there is a need for a centralized marketplace, where investors can trade any type of “structured” financial product, but anonymously and without being beholden to the informational monopoly of subsector specialists.

There exists a need for a method to automate and centralize the system by which investors trade “structured products” within the fixed income marketplace. Structured products are defined as fixed income securities derived from cashflows of some type of receivables that are pooled together into a single structure. The cashflows are then carved up according to structure rules of the particular deal or may simply flow thru in a nonstructured method (commonly called a passthru). “Structured Products” is a loose term for all securities that fall into the above description, but in the preferred embodiment of the disclosed system the products traded will be specifically:

(MBS) “Passthru's” or (TBA's) Mortgage Backed Securities

(ARM) Adjustable Rate Mortgages

(CMO) (Agency and Whole Loan) Collateralized Mortgage Obligations

(ABS) Asset Backed Securities

(CMBS) Commercial Mortgage Backed Securities

(CBO/CLO/CDO) Collateralized—Bond/Loan/Debt Obligations

The securities in this universe, excluding TBA MBS, tend not to trade on a price basis but rather on a spread in basis points to a liquid benchmark security, index, or interest rate. Increasingly, these types of securities are now trading on an OAS basis. OAS stands for option-adjusted spread. This is simply a different type of spread that takes into account the optionality of the security coupled with volatility. The trading of these types of structured securities requires a great deal of time consuming analytical analysis of the individual securities. They are looked at on their individual merits as well as on a relative value basis to like securities and more liquid fixed income sectors such as US Treasuries and the TBA MBS sector. While many securities in this sector can be grouped into similar classifications, each security requires individual analysis before a transaction can take place. To compare this process to other commodity like sectors in the fixed income marketplace such as the trading of U.S. Treasuries, Municipal Bonds, Corporate Bonds, Money Markets, Brady Bonds, or Futures would be an error. It would be similar to selling new cars where pricing information is transparent and readily available, to antique cars where there is little to no information, and requires significant research and a separate case-by-case analysis.

Currently, securities in the structured products vertical market do not trade on any centralized exchange. Rather, each broker dealer through their own internal sales force uses the telephone to buy and sell structured product securities on a negotiated basis. Today, individual dealers offer securities or bid on securities based on nothing more than their opinion of where the security should logically trade when compared to like securities in the marketplace. To further cloud the liquidity and transparency of the marketplace, many dealers tend to specialize in certain subsets of the structured products universe. Meaning, investors must attempt to keep a scorecard of which particular structured products are traded accurately and with significant liquidity on a dealer-by-dealer basis. Subsequently, the marketplace has developed in a manner whereby each individual broker dealer has carved out a handful of niches in a few particular sub-sectors of the structured products universe. There is no one dealer that trades all of the various types of structured products, but rather “pockets of “liquidity” broken down by product and by dealer. The disclosed system will provide price discovery and objectivity, along with greater liquidity, to the trading of structured products. It will enable investors to “one stop shop” for all types of structured product securities.

Current Transaction Operation

Customers of financial institution fixed income desks use predominately two methods for transacting in structured products:

1. Verbal Negotiation. End users, or buy side institutions negotiate with one or more dealers over what either party is willing to pay for a particular security. The downside to this method is that the customer may not call the dealer that actually has the cheapest offering, and or the highest bid at that particular moment in time because of the aforementioned “pockets of liquidity”. It is also time consuming, and requires trial and error telephone calls. It vastly limits the number of potential buyers or sellers because there is no centralized e-marketplace. Typically the size of the universe that is involved in any purchase or sale of securities is limited to the size of the portfolio managers' Rolodex of Wall Street contacts. The most efficient way to maximize execution and or return for any transaction is to search out the broadest audience of likely beneficiaries for the securities in question. This has lead to the second most commonly accepted practice of trading, known as “Bid Lists.”

2. Bid Lists. A Bid List is nothing more than an auction of securities. A list is sent out by the seller to all of the dealers whom the seller believes may be most interested in buying the securities they intend to sell. (IE, those dealers that specialize in the particular type of securities in question) Generally, the dealers are given sufficient time to formulate their bids on all or some of the securities for sale, and then are required to submit their bids to the seller at a specific pre-determined time. Then the bonds are awarded to the highest bid on a case-by-case basis.

One immediate problem of the Bid List system is that customers are potentially revealing their intention to sell securities to a dealer that is not a natural buyer of that particular type of security, and in fact could also be a natural seller at the same time. This information all too frequently may spur a dealer to sell or liquidate holdings in similar or like securities immediately prior to the Bid List transaction time. This type of action is called “Front Running.” It can happen often and is very hard to track and enforce. It is an unfortunate consequence of the nature of the business today. Clearly, if this practice could be eliminated it would significantly benefit investors and market liquidity.

Another problem that frequently occurs is that when the Bid List or auction close time does arrive, many dealers have no bid and instead plead for more time. They do this because they believe customers, whom they have re-offered the bonds too, will shortly call back with bids for bonds on the Bid List. This process usually results in a Bid List that was scheduled to trade or transact at 1:00, trading at 1:30 or 2:00. This type of begging and pleading for more time has only served to reduce liquidity in the structured product marketplace because the bonds do not end up trading in a timely and orderly manner.

At the same time, some customers that submit Bid Lists to dealers have begun to “Shop the Bids,” often after the transaction time occurs. Numerous buy side accounts have taken to calling dealers back after they have received all of the bids from the various dealers that the Bid list was submitted too, and then try to offer the bonds at a slightly higher price to the top bidders, instead of awarding the bonds as they are supposed to do. Essentially, the buy-side uses the information it gainers from the Bid List in a proprietary manner to squeeze out a dollar price even higher than the best bid on the Bid List out of the brokerage community. The brokerage community is then forced to “pay up” in fear of damaging their existing business relationship with the buy-side account. These deceitful practices have stripped the trading of these types of securities of all integrity, and plainly demonstrate the need to automate and restore honesty and integrity to the process.

The current bid-list system on Wall Street within the structured products market has degenerated significantly over the past few years in ways that hurt both dealers and investors. This has been brought on by there simply being far fewer dealers through mergers and consolidation, combined with greatly reduced capital commitments by the dealers involved in the structured products market to position bonds in inventory. As a result, many dealers only put reasonable bids on bonds in the open marketplace, only when they have a pre-existing bid from a client to back-up their marketplace bid. This puts dealers in the position of having no bid (or a very poor bid) frequently, unless a potential buyer surfaces and gives the dealer a bid from which to base their own bid level. Consolidation coupled with greatly reduced capital commitments by the brokerage community without question has significantly reduced liquidity in the fixed income structured products marketplace.

Another problem caused by auction sellers is that they often only have a vague idea of what an accurate valuation of the securities in question may be. Because structured products are so complex, they naturally have a broader trading range then the more commoditized products. When the brokerage community values buy-side portfolios or “mark them to market,” the broker dealers typically value the portfolios in a manner best suiting their own self-interest. (IE, if the dealer pricing the portfolio happened to sell the customer the securities in the portfolio, the dealer may tend to inflate the valuations to make themselves appear more attractive) Often the securities in question are quite old and have not been traded recently, or are so esoteric that some dealers are unfamiliar with the securities, or do not have a model for the cash flows and or deal structure. As a result, it is not uncommon for buy-side customers to submit Bid Lists and then refrain from transacting because the bids returned were considerably lower than anticipated.

Before market practices degenerated to the stage they are currently, the seller would have been absolutely obligated to transact at the deemed execution time stated on the Bid List, even if they were not entirely happy with the bid levels. Today, many bid lists come and go with good bids from dealers but no bonds trade because the client was apparently “off the market” in terms of their expectations, or even worse, the seller simply put the Bid List auction out with no intent to sell at all, but rather to use the bids to more accurately price their portfolio.

Another problem with auction systems, particularly affecting the trading of structural products, is the practice of “propping the market.” “Propping the market” is a practice whereby an institution will submit an artificially high bid to scare off other likely suitors of the same security. Then the institution that is “propping the market,” can reduce its bid at the last moment and purchase the security at a much more favorable level with considerably less competition.

Clearly given the problems described above, it becomes easy to see why dealer and customer dissatisfaction with the current auction system grows. With the advent of technology like the Internet, it is now possible to eliminate these problems completely, while standardizing trading practices and improving liquidity throughout the fixed income structured products marketplace. The real-time, secure, and unique electronic BID LADDER user interface technology of the disclosed system will alleviate these problems.

### SUMMARY OF THE INVENTION

The approach of the disclosed system is to create a centralized B-to-B e-marketplace site where potential buyers and sellers of structured products can meet anonymously and trade securities. The system's site utilizes the same methodologies incorporated in today's “hit-or-miss” search by structured product dealers and investors, i.e., to generate the largest possible audience and allow them to meet in a common anonymous and transparent electronic marketplace to realize the best prices the market will bear, while standardizing and automating the process to increase market liquidity and eliminating the dishonest and deceitful trading practices of today.

It is worth noting here that in 1990, dealers and customers each owned approximately 50% of the aggregate total of bonds in the structured products universe. Consolidation has changed this relationship significantly. Today customers own approximately 85% of the bonds and dealers the remaining 15%. In short, dealers are still the market makers and liquidity providers on short notice, but the voice of the investor base has truly grown because they now are the largest capital committees in the marketplace by a large margin.

With further consolidation happening monthly among the large dealer ranks, the imbalance from historical norms between who owns the bonds will cause investors to become such the dominant holders, that dealers will likely become less relevant over time. Hence, the need for institutional investors to be able to transact between themselves is essential, instead of being forced to trade through the current dealer oligopoly. The e-marketplace of the disclosed system will “free-up” the current dealer driven bottleneck of transaction volume and dramatically enhance market depth and liquidity by providing a new technologically advanced trading marketplace.

It is also very important to note, that in the preferred embodiment of the system, the auction host will utilize a recognized, independent and reputable transaction clearing entity (e.g. BNY Clearing Services International, a wholly-owned subsidiary of The Bank of New York) to clear and guarantee all trades executed on the system. This means that both buyer and seller in any transaction will have such an entity as the principal and counterparty on all executed transactions. This allows for truly anonymous trading, whereby you will have traditional dealer-to-investor trading, but also investor-to-investor, and possibly dealer-to-dealer trading.

Central to the home page of the preferred embodiment's auction site is a matrix that breaks out all of the securities in the structured products' vertical market space. The matrix is spread across different average life buckets with symbols in each bucket to denote the number of live price-matches and auctions currently taking place within each average life bucket. By clicking on any symbol in the global navigation matrix, users will move directly to live-trading taking place in that particular average life bucket.

In a further embodiment, the system will still allow for traditional negotiated sale type of trading of securities through a Price Match option, whereby sellers or buyers will post securities with a price or spread where they are willing to buy or sell bonds in hopes of attracting interest on the opposite side of the trade. Essentially, beginning an electronic haggle or negotiation to find a middle ground.

Since most securities in the vertical auction page are somewhat unique, the more likely venue to trade securities will be through the automated electronic auction system of the preferred embodiment's auction host. Clicking on a symbol within the global navigation page, one can rapidly view all auctions either currently active, or scheduled to take place in the near future. Once one clicks on a particular auction of interest, they will move directly to the auction page for that particular auction. Central to each and every auction page of the preferred embodiment is the Bid Ladder.

The Bid Ladder feature of the preferred embodiment is an automated real-time Internet based auction technology, which allows all institutional investors and broker dealers that participate on the auction host's web site to easily view and monitor, in a graphical fashion, the entire breadth and depth of the market for any bond they wish to buy or sell. This is accomplished in a real-time, clear, secure, and efficient fashion with complete anonymity and market transparency to both buyer and seller.

The architecture implemented in the preferred embodiment creates an environment of absolute transparency and anonymity and increases overall liquidity in the fixed income markets. The open architecture publishes virtually every bid and offer received, and makes available all transaction information to the public. The information published through the Bid Ladder indicates the overall interest in a security by graphically demonstrating the actual breadth and depth of the market in real time, which has never before been published or open to the public. The disclosed system is also the first system to provide this type of information to the public in a real time executionable trading environment.

Bids made from the beginning of the auction until the auction closes, or is ended, are anonymously published in real time. At all times, the current high bid is displayed in an active updating real time moving column with subsequent lesser bids stacked underneath the high bid for all bidders or participants to monitor. Along side each bid, additional information may be listed including, for example, the time each bid was submitted. The Bid Ladder also continuously store bids, preferably in increments of one one-thousandth of a second and automatically orders all bids received by price/spread and time. Preferably, the best price/spread bid at the earliest received time will automatically rise to the top of the Bid Ladder followed by all subsequent bids in descending order.

Additional features of the present invention include: (i) integrated live market data feeds; (ii) submission of bids on a spread basis as well as a price basis (the accepted industry norm); (iii) the ability to automatically take a basis point spread bid, add it to the underlying benchmark yield (such as the ten year Treasury note's) and then calculate the all-in yield for the security being sold and publishing the price that reflects the spread bid. The integration of live market data feeds enables the Bid Ladder to dynamically adjust all prices within the Bid Ladder to reflect any market movements or fluctuations in real time with no user input or browser refreshing. This feature provides superior reliability and price accuracy to users, because existing web-based systems require users to repeatedly re-fresh their Internet browser to monitor market movements.

The reason for the conversion from a spread bid to a dollar price bid is necessary since absolute dollar price is important in the trading of structured products (mortgage backed securities tend to begin lagging US Treasuries as they approach PAR). Thus, it is a very valuable of the present invention for participants to see the dollar price that corresponds to a spread bid change instantaneously as the market moves and the auction process progresses.

All bids are live and are firm orders to purchase securities. In the preferred embodiment of the trading system, all bids are kept live and firm for a minimum time period, after which time the bid, or bids may be cancelled at anytime. A ten-second minimum rule is preferred to discourage impropriety on the system. In addition, it is also preferable that all users of the present invention be trained and required to sign a binding user agreement that lists all rules governing the system's trading platform prior to being issued a password.

The present invention also addresses the problem of cancellation of bids. Currently, when customers wish to cancel a bid, they must call back their salesperson to pull the bid, the salesperson then has to yell to the trader that the “bid is out” and then the entire phone chain must relay confirmation of the cancellation back to the customer. Almost all structured product trading today occurs through this antiquated phone chain system. In the disclosed system, however, a customer can cancel a bid at the click of a mouse and forego the time intensive phone chain.

The “10 second rule” is also important because it eliminates the common practice of “propping the market.” “Propping the market” is a practice whereby an institution will submit an artificially high bid to scare off other likely suitors of the same security. Then the institution that is “propping the market,” can reduce its bid at the last moment and purchase the security at a much more favorable level with considerably less competition. The ten-second rule accomplishes this because sellers have the ability to instantly end an auction prior to the specified auction close time if they happen to see a particularly strong bid submitted. The requiring of all bids to be firm for a minimum of ten seconds will eliminate this practice because of the significant risk of being forced to purchase the securities at a higher than normal price.

There are many unique features of the Bid Ladder system that are entirely different from the way business is transacted today. One feature is that the Bid Ladder system allows buyers and sellers to directly interact and trade while remaining anonymous. Today, customers who are interested in purchasing securities from a “Bid List” circulating throughout Wall Street have no means of accessing it directly. The only way an institution can participate in the bidding for securities from a “Bid List” is through a broker dealer. This puts the investor at a distinct disadvantage because the broker dealer acting as the intermediary between the buyer and the seller will use its discretion and create a difference between the bid submitted to them from the interested buyer, and the seller. The dealer will keep the difference between the interested buyer and the seller as a profit. As business is currently conducted today, the buyer and seller never know where the seller sold, or where the buyer bought. It is all clouded in secrecy by the dealer intermediary. The Bid Ladder system eliminates this inefficiency from the market completely, and dramatically increases market transparency.

As previously stated, the present invention allows for complete transparency of all transactions. The Bid Ladder actively publishes all bids and offers submitted to its auctions and trading functions for institutions to monitor, and actively flashes the price/spread levels when a transaction occurs. The system's trading platform also stores and archives all transaction history on the site for historical and research purposes. At anytime, any user of the Internet site can search and look up where a bond traded on any particular day. This capability and transparency is derived from the functionality of the Bid Ladder system.

Institutions submitting bonds to be auctioned on the system can also be required to post a “reserve price” or “reserve spread.” A reserve price or spread is a level at which the seller is legally bound to trade the security being auctioned if the level is either met or exceeded at the close of the auction. However, the seller in every auction can have the option as to whether or not they wish to publish this execution level to the public.

This reserve requirement serves a two fold purpose and protects both the buyer and seller. First, if published, it will educate all bidders to approximately where the seller is comfortable selling the securities, and ensure both accurate and realistic bids. Second, if not published, the bidders will know that since all sellers are required to input a reserve on the system, there is a guaranteed absolute level where the securities will trade if it is met. This gives a buyer comfort because they know the institution on the other side of the trade is a “real” seller and not just someone looking for pricing information. The seller is protected because they can control at which level they are comfortable trading.

Bidding in the system's preferred embodiment also starts at a specific time and ends at a specific time with no exceptions. This no exception policy eliminates today's problems of bid lists dragging on for lengthy periods of time past the scheduled execution time. This rule will enhance liquidity and return integrity to the auction process by facilitating timely and orderly transactions.

A significant problem for the largest fixed income portfolio managers of today is the depth of the market problem. Numerous large fixed income money managers control extremely large positions in single securities. Sometimes these institutions need to sell a significant portion, or liquidate these positions. This generally causes a large market disruption resulting in a large reduction in execution price. This is caused by the lack of anonymity in today's market.

The disclosed system significantly mitigates this problem because institutions can sell off the positions in pieces anonymously without alerting attention as to “who” is doing the selling, and thus obtain significantly better price execution. In the system's preferred embodiment, the transaction would appear as a lot of similar trades in one security. It could be one institution, or ten. This is impossible today. The instant one of these institutions enters the market, the dealer community assumes that the entire position will be sold, and the market trades down.

Lastly, the system's Bid Ladder provides a unique “Top Bid” button. This button enables bidders to increase their bid without the need to type any numbers. It is a quick way for a buyer to increase their bid by a minimum increment. In a structured product security auction, the increment should be one quarter of one thirty-second in price, or one quarter of a basis point in a spread auction. Such figures could be established in binding “rules of trading” to which the users agree. This unique Bid Ladder tool automates today's trader-to-salesperson phone chain system of negotiation. On an auction page of the system's preferred embodiment, if an investor wishes to increase their bid in the Bid Ladder, all they have to do is click their mouse on the “Top Bid” button. This simple keystroke saves time, increases liquidity, and maintains the user's anonymity. It also reduces the margin of error by eliminating the possibility of a human translation error by eliminating the human phone chain.

The central point to be drawn is that the current structured products trading methods utilize ancient technology, people and phones. It consists of small private auctions where there are a limited number of participants that have no idea how many other people are bidding, how strong an auction is, what it takes to buy a bond, or even if the bond eventually trades at all. Generally, within hours of an auction today, the identity of the seller becomes well known throughout the Wall Street community as a result of human traders, salespeople, and customers gossiping on the telephone. There is very little anonymity, and the market is far from transparent.

In contrast, by trading with the disclosed e-marketplace: (i) users maintain their anonymity, (ii) transactions are completely transparent because the Bid Ladder instantaneously publishes all bids and offers to illustrate the breadth and depth of the market, and (iii) all transaction data is readily available to the public and all market participants. In short, it is the exact opposite of every negative of current bond and structured product trading practices.

Accordingly, in one aspect of the present invention, a method for anonymously buying and selling a structured financial product over a computer network includes providing a host for receiving information for the offer for sale of a structured financial product from a first client, anonymously publishing the offer for sale of the structured financial product over a computer network by the host to a plurality of second clients over the computer network for a predetermined period of time, initiating the offer for sale of the product over the network at a prescribed starting time, providing an opportunity for the plurality of second clients to bid on the product in real-time during the period of time, automatically publishing to the plurality of second clients viewing the sale of the product each bid in real-time as each bid is submitted by one of the second clients, wherein a substantial number of all submitted bids are displayed together during the offer for sale, and awarding the structured financial product to a second client of the plurality of the second clients submitting the highest bid by the end of the predetermined period of time.

In another aspect of the present invention, a system for anonymously auctioning a structured financial product over a computer network includes a computer network, a first client in communication with said network, a plurality of second clients in communication with said network and a host in communication with said computer network. The host performs the method as recited above in the previous aspect.

In yet another aspect of the present invention, a computer readable media including computer code comprising instructions for performing the method according to the first aspect is provided for.

In still yet another aspect of the present invention, a computer system includes storage means for storing data and a processor programmed to preform a method for buying and selling a structured financial product over a computer network according to the first aspect.

In another aspect of the present invention, a method of realizing an interest in the sale of a structured financial product includes providing a host in communication with a computer network, the host for storing a plurality of structured financial products offered for sale by a plurality of respective first clients in communication with the host in a first database, displaying at least one field to a second client in communication with the computer network for entering a query term for searching said first database, and searching the first database with the query. The query includes a first term for finding specific structured financial products of the plurality of structured financial products, and the second client anonymously searches the database using the query. The method also includes displaying a result of the query, where the result includes at least one structured financial product, anonymously indicating by the second client an interest in purchasing at least one structured financial product, storing the interest of said structured financial product in the first database, and determining an interest gauge for the structured financial product based upon said interest by the second client.

In yet another aspect according to the present invention, a method of alerting a second client of the sale of a structured financial product includes providing a host in communication with a computer network, where the host stores a plurality of structured financial products offered for sale by a plurality of respective first clients in communication with the host in a first database, registers a second client with a second database, the registration including information relating to interest of the second client in purchasing a particular structured financial product, and notifying the second client when the particular structured financial product is offered for sale by a first client.

In still yet another aspect of the present invention, a system for tracking a structured financial product includes a host in communication with a computer network, the host including storing means for storing a plurality of structured financial products offered for sale by a plurality of respective first clients in communication with the host in a first database, and buying and selling means for buying and selling said plurality of structured financial products, registering means for registering a second client in communication with the network in a second database so that the second client can bid on said structured financial products offered for sale. The registration including uploading portfolio information comprising current security positions in structured financial products of said second client. The system also includes valuating means for valuating the security positions based upon transaction history of the sale of structured financial products from the host.

In another aspect of the present invention, a computer readable medium having stored thereon a data structure includes a first field containing data representing a structured financial product which has been sold and a second field containing data representing a market condition at the time of sale of said structured financial product.

In yet another aspect of the present invention, a method of valuating a structured financial product includes providing a host for receiving information for the offer for sale of a structured financial product from a first client, anonymously publishing the offer for sale of the structured financial product over a computer network by the host to a plurality of second clients over the computer network for a predetermined period of time, initiating the offer for sale of the product over the network at a prescribed starting time, providing an opportunity for the plurality of second clients to bid on the product in real-time during the period of time, awarding the structured financial product to a second client of the plurality of the second clients submitting the highest bid by the end of the predetermined period of time, storing information related to the sale of the structured financial product in a first database, the information comprising first data representing the time at which the structured financial product was sold and second data representing a market condition at the time of sale of the structured financial product. The method also includes searching the database for finding particular structured financial products which have been sold, displaying the result of the search, where the results include at least one structured financial product and associated first data and second data.

Other aspects of the present invention include systems and computer readable media for carrying out the methods and processes described above.

### BRIEF DESCRIPTION OF THE FIGURES

These and other features, aspects and advantages of the present invention will become better understood with regard to the following description and accompanying drawings, flowcharts and screen shots where:

FIG. 1 is a simplified illustration of a client-server environment in which the present invention may be implemented.

FIG. 2 illustrates a screen shot associated with the Bid Ladder system according to the present invention showing a current auction.

FIGS. 3A-3B illustrate location of security type for buying or selling such a security.

FIGS. 4A-4B illustrate screen shots of examples of ongoing auctions. FIG. 4A illustrates the screen that a seller of the auctioned security would see when using the present system; FIG. 4B is the screen a potential buyer of the security would see when using the present system.

FIGS. 5A-5D illustrate screen shots of a bidding process where a buyer submits a bid to an ongoing auction.

FIG. 6 illustrates a screen shot of the bid submitted via the screen illustrated in FIGS. 5A-5D.

FIGS. 7-9B illustrate screen shots of seller screens for a seller to list a security for auction on the system according to the present invention.

FIG. 10 illustrates a bond alert registration page.

FIG. 11 illustrates a screen shot of settlement and clearing instructions for the present system.

FIG. 12 illustrates the logic underlying the customer application, including market participant and administrative screens for client applications.

FIG. 13 illustrates the auction host's application infrastructure architecture, to which client application may connect by internet.

FIG. 14 diagrams the auction host's production network, with redundant servers and other facilities for ensuring availability and reliability.

FIG. 15 illustrates a security architecture diagram for the system according to the present invention.

FIG. 16 illustrates the various computer hardware/apparatus components comprising the preferred embodiment of auction host's production network, along with their interconnections.

FIGS. 17A and 17B illustrate a process flow of the Bid Ladder system, according to the present invention.

FIG. 18 illustrates a process flow of a reverse inquiry embodiment according to the present invention.

### DETAILED DESCRIPTION OF THE PREFERRED EMBODIMENTS

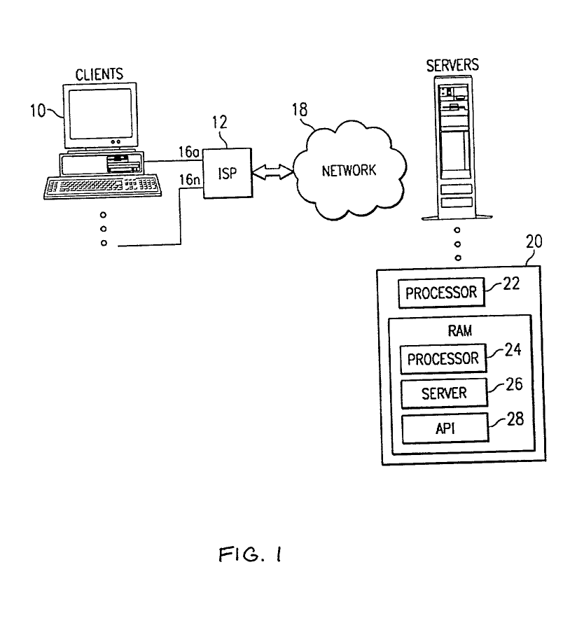

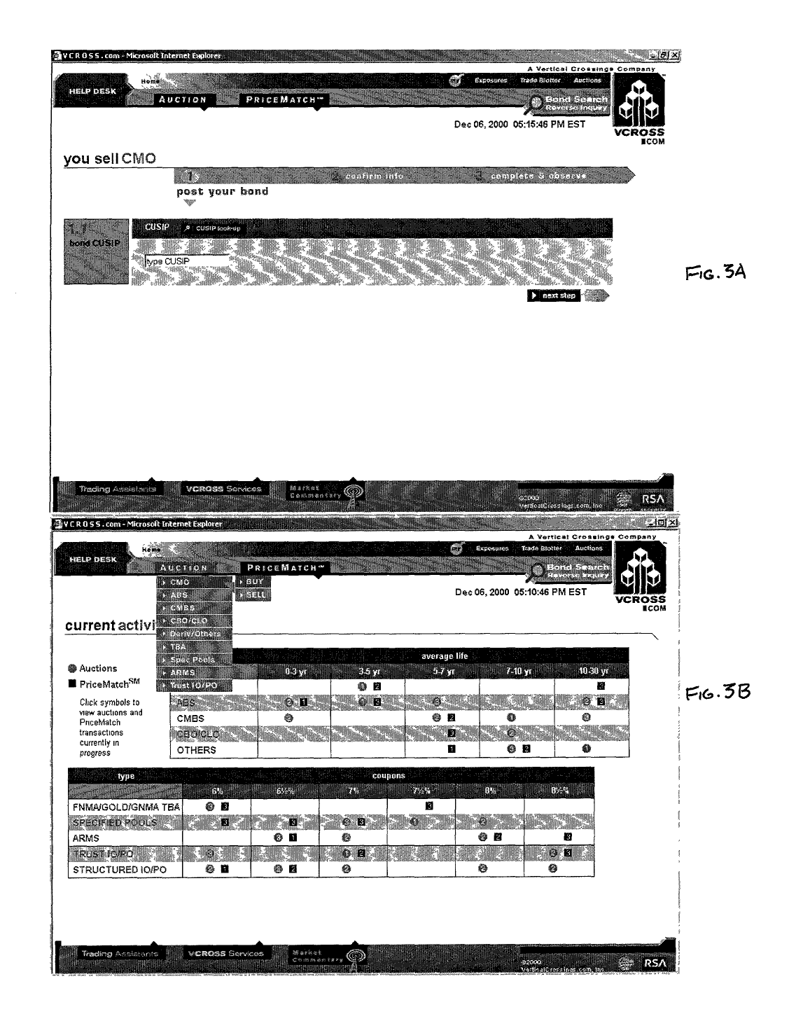

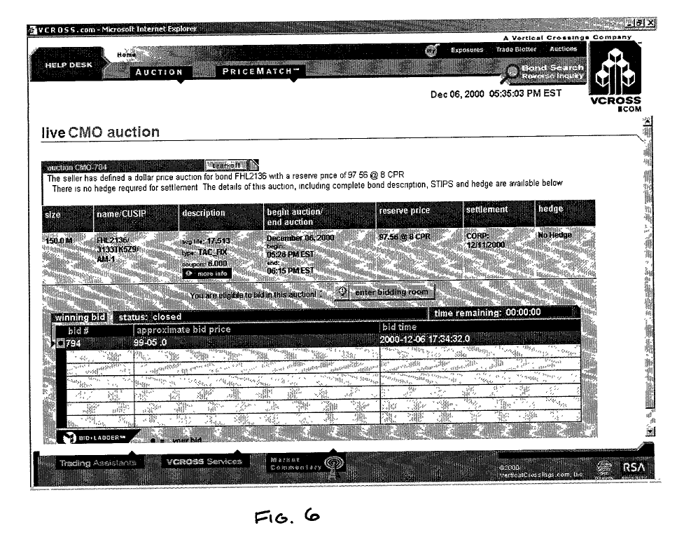

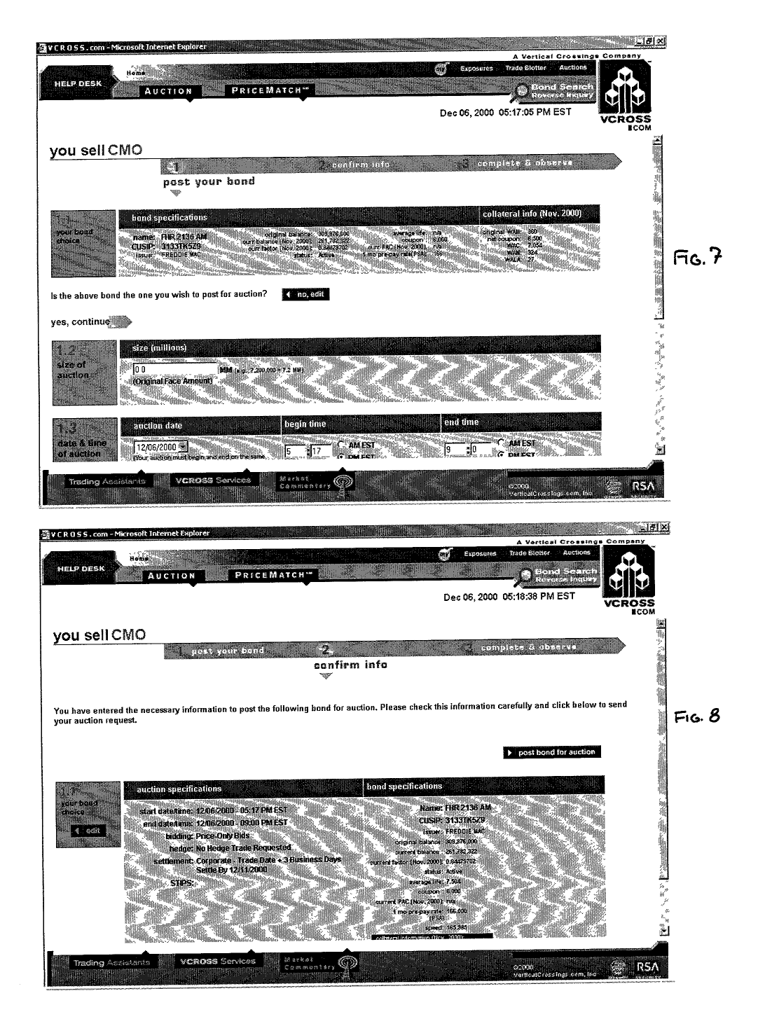

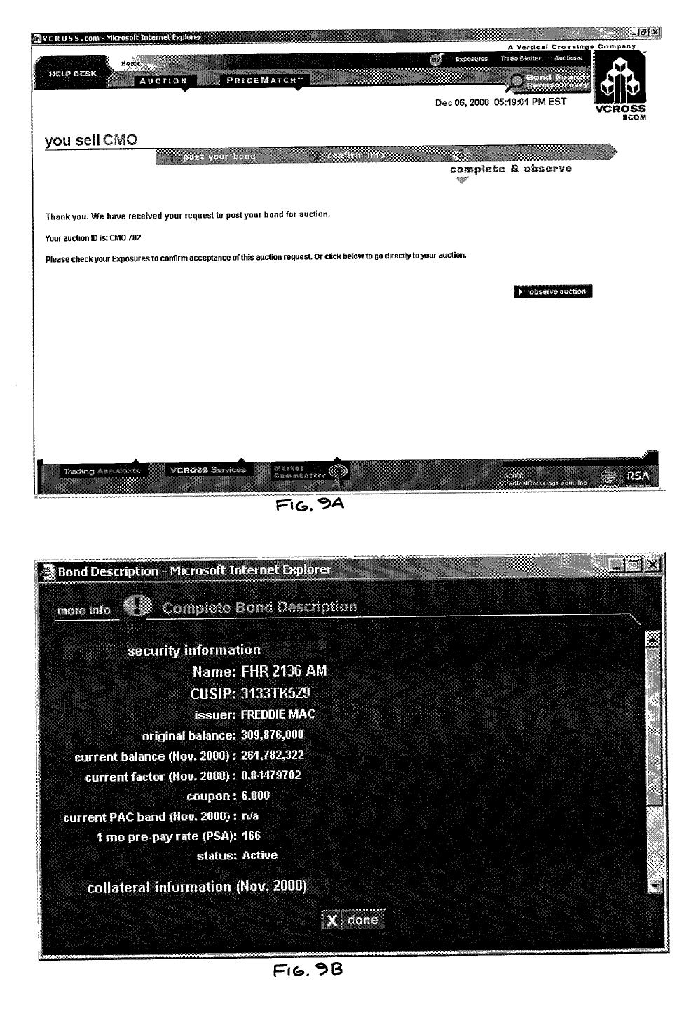

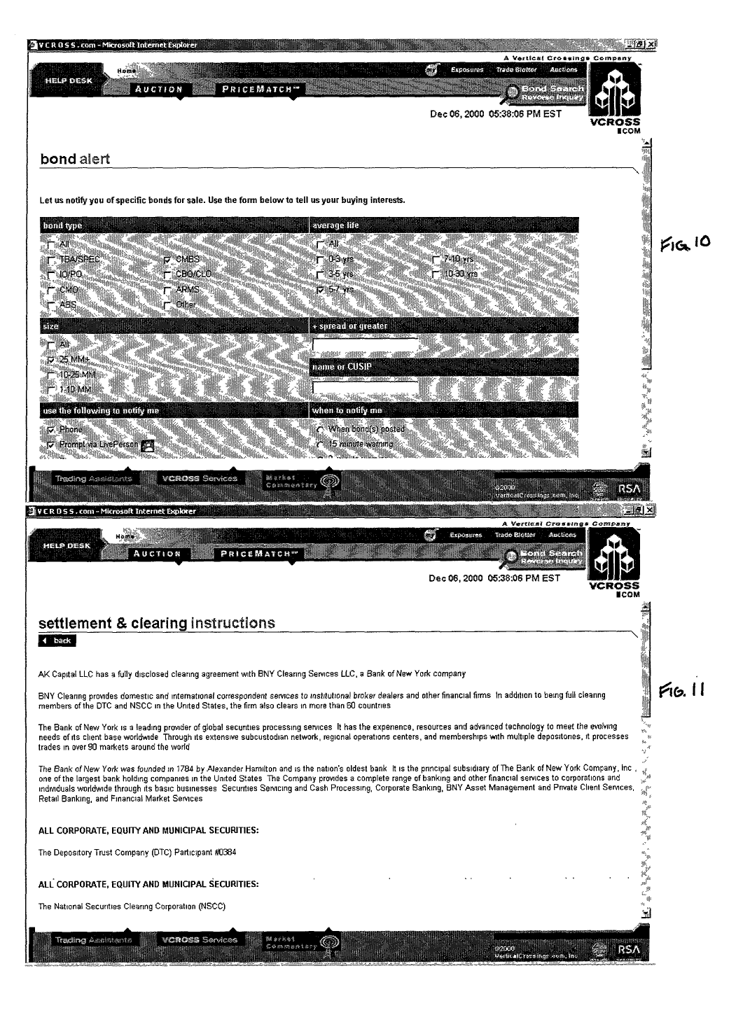

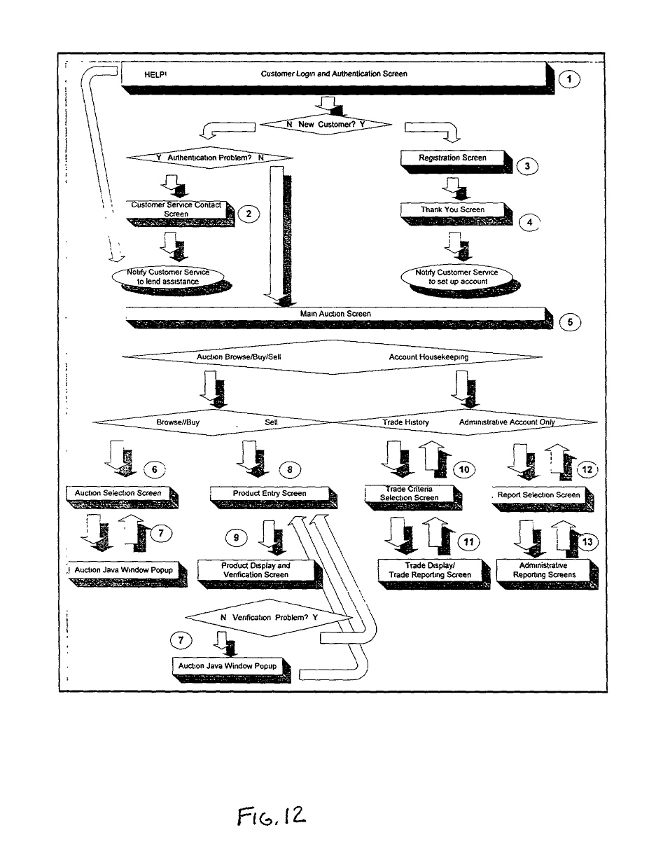

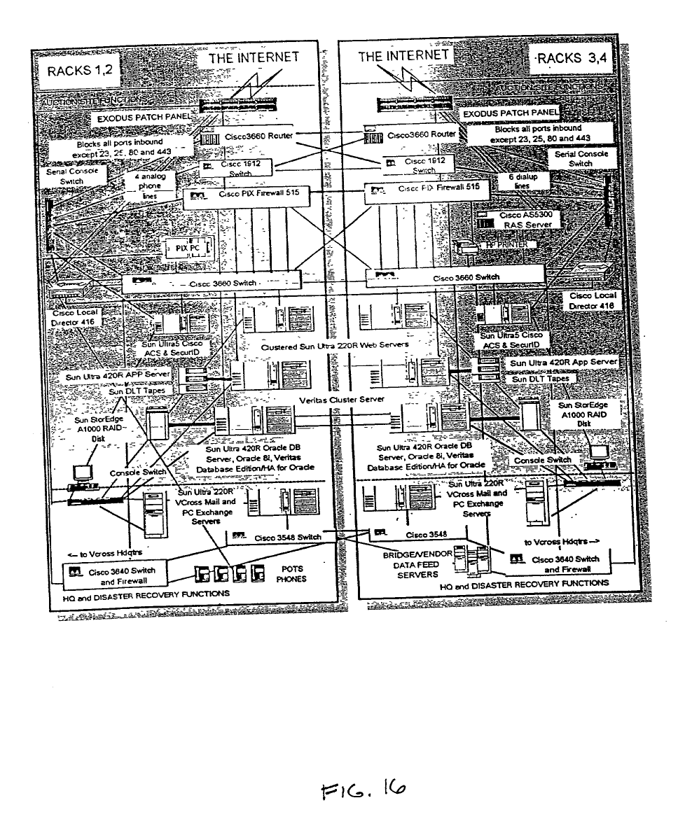

The preferred embodiments of the present invention will now be described in detail with references to FIGS. 1 through 18. Although the system and method of the present invention will be described in connection with these preferred embodiments and drawings, it is not intended to be limited to the specific form set forth herein, but on the contrary, it is intended to cover such alternatives, modifications, and equivalents, as can be reasonably included within the spirit and scope of the invention.

A representative system in which the present invention is implemented is illustrated in FIG. 1. A plurality of Internet client machines 10 are connectable to a computer network Internet Service Provider (ISP) 12 via a network such as a dialup telephone network 14, DSL, or a local area network (LAN). ISP 12 interfaces the client machines 10 to the remainder of the network 18, which includes a plurality of web content server machines 20. Network 18 typically includes other servers (not shown) for control of domain name resolution, routing and other control functions. A client machine typically includes a suite of known Internet tools, including a Web browser, to access the servers of the network and thus obtain certain services. These services include one-to-one messaging (e-mail), one-to-many messaging (bulletin board), on-line chat, file transfer and browsing. Various known Internet protocols are used for these services. Thus, for example, browsing is effected using the Hypertext Transfer Protocol (HTTP), which provides users access to multimedia files using Hypertext Markup Language (HTML). The collection of servers that use HTTP comprise the World Wide Web, which is the Internet's multimedia information retrieval system.

As will be seen, a given server (or servers) in the computer network operates a web site on which the present invention operates. Users, namely, users of client machines, may browse the site and register therein to buy and sell structured financial products. A given client machine and the server may communicate over the public Internet, an intranet, or any other computer network. If desired, given communications may take place over a secure connection. Thus, for example, a client may communicate with the server using a network security protocol, such as Netscape's Secure Socket Layer (SSL) protocol or the IETF's Transport Layer Security (TLS) protocol.

A representative client is a personal computer, notebook computer, Internet appliance or pervasive computing device (e.g., a PDA or palm computer) that is x86-, PowerPC, or RISC-based. The client includes an operating system such as Microsoft Windows, Microsoft Windows CE or PalmOS. As noted above, the client includes a suite of Internet tools including a Web browser, such as Netscape Navigator or Microsoft Internet Explorer, that has a Java Virtual Machine (JVM) and support for application plug-ins or helper applications. A representative web server is an IBM Netfinity server comprising a RISC-based processor 22, a UNIX-based operating system 24 and a web server program 26. The server may include an application programming interface 28 (API) that provides extensions to enable application developers to extend and/or customize the core functionality thereof through software programs including plug-ins, CGI programs, servlets, and the like.

The present invention is preferably implemented as a computer program operative at a web server. Although the invention may be implemented on a single web server, one of ordinary skill in the art will appreciate that the described functionality may be implemented across multiple servers. Moreover, the web site may be mirrored at additional servers in the network and, if desired, one or more management servers or other computer resources may be used to facilitate various billing, accounting and administrative functions as a “back end” to the underlying site.

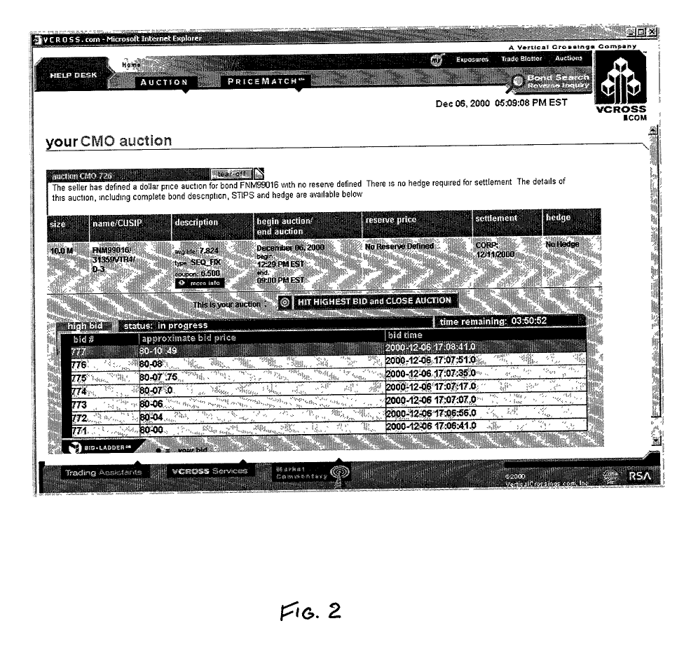

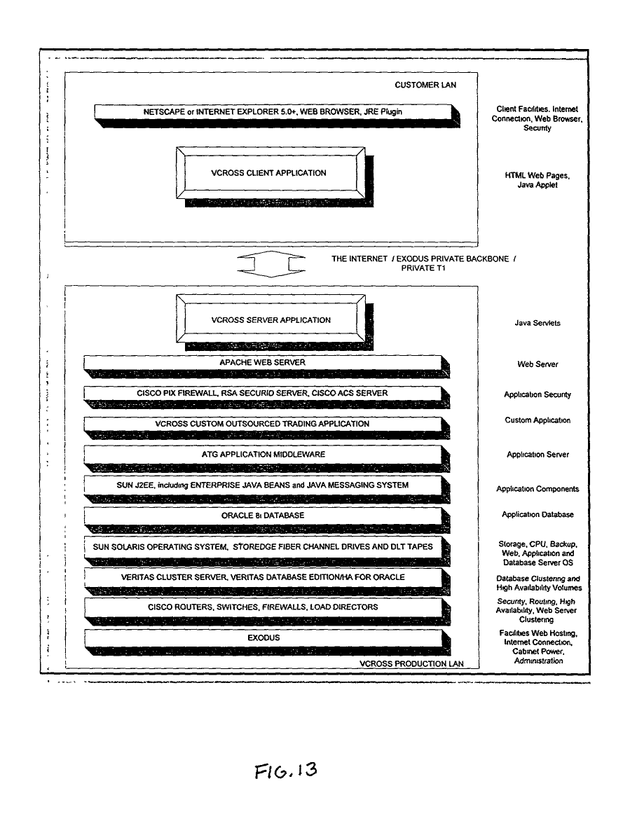

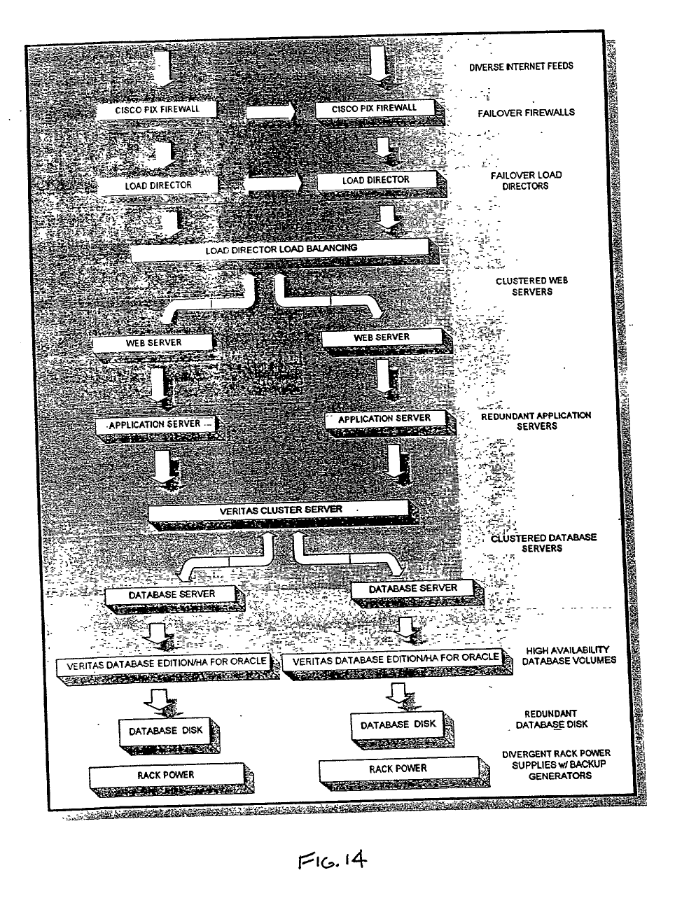

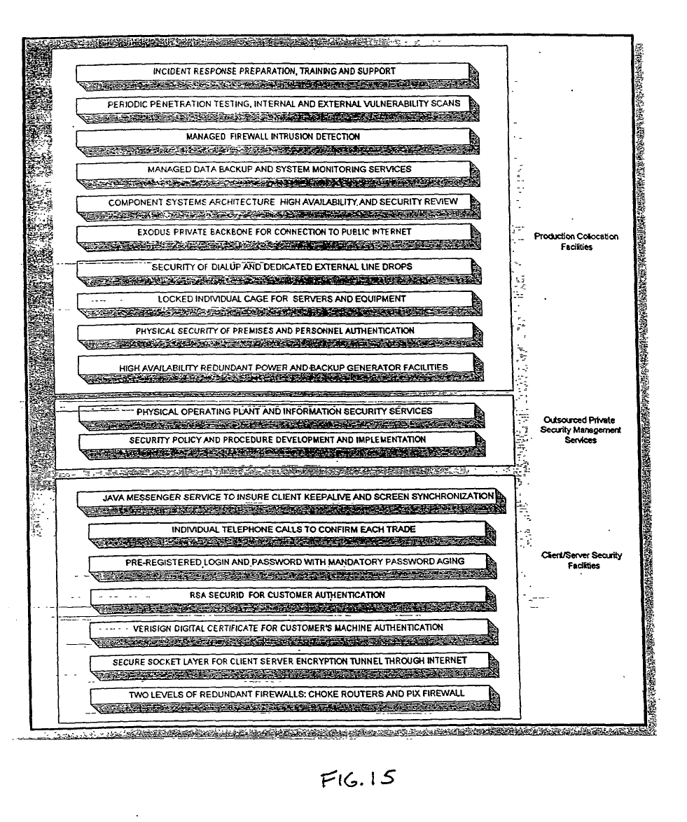

The computer program at the web site includes appropriate display routines for generating sets of display screens that together comprise a user interface for the site. To that end, FIGS. 2-11 are representative display screens, although the particular screen layouts should not be taken to limit the scope of the present invention. An overview of the customer and administrative screens are illustrated in FIG. 12, while other system architecture is illustrated in FIGS. 13-16.

The Bid Ladder system is a fully Internet-enabled, versatile, real-time auction display and sophisticated management and queuing engine for providing visual indication of the depth of market bids (preferably, but not necessarily, in the financial structured products sector), which has been designed to work in a standard browser with no special firewall or installation requirements. Although preferably delivered as an extremely “lightweight” Java applet, it relies upon a secure conventional middleware auction engine residing on the auction host's server farm, which furnishes the graphical interface with constant refreshing of live, reliable bid data.

The Bid Ladder consists of a multicolored visual matrix that is an abstraction of a LIFO, or “last-in-first-out” stack showing a number of bid entries. It is preferable that the stack be at least seven entries deep. When auction goes live, the most recent and highest bid is pushed onto the top of the “ladder”, and the bottom-most bid entry drops off. An arbitrary bid label is generated for each bid in order to protect anonymity as the left hand column of the matrix, and on the rightmost column the time of each bid's acceptance is indicated, with the prices and spreads displayed in columns in between. During rapid periods of bidding, each higher bid is perceived as pushing the bids beneath itself down the rungs of a ladder, such that an animated ladder of bids provides a unique and indicative visual metaphor for the auction process itself.

The Bid Ladder is preferably delivered as a Java applet that may be detached from the main application as a stand-alone “tear-off ‘window, or may be stored on an auction index page for convenience. In this case, only a limited number of the most recent bids (preferably three) are provided as an indication of the depth of the market. In either case, the Bid Ladder can be easily restored to its contextual home within the appropriate auction page with a mouse click. It may also be expanded further to show a full bid history.

The Bid Ladder does not require any user interaction in order to display updated activity in the auction vehicle, such as active auction status changes, auction time countdown, new bid entries, or automatic bid repricing in line with live market benchmark volatility. Finally, a highlight color may be used to denote any bids placed by the auction bidder viewing it, automatically customizing itself according to the site and login user id in situ.

The auction management engine handles both spread and price-based selling vehicles, and maintains session persistence with the remote Bid Ladder applets in order that the ordinarily stateless Internet connection does not time out due to its limited interactivity requirements. The auction management engine constantly updates the Bid Ladder applets with newly authenticated bids, and also serves to alert the Bid Ladder to remove bids that have been withdrawn from the auction.

As bids are entered on the system's auction page they are first sent to this auction queuing engine, which handles auditing, throttling, and database entry functions in a middleware module separate from both the system's web page servlet engine and the database engine components themselves. By separating this function into a proprietary bid management and queuing engine, the auction element itself is separately scalable from either the web server or database functions of the auction host's web site.

Buttons integrated into the website alongside the Bid Ladder enable the seller to hit the highest bid (see FIG. 2) and close the auction when he is satisfied with the price level, or the user to cancel a bid after a specified time of bid exposure has elapsed. The action of each of these buttons, as well as the confirmation of a new bid by the user, send a message into the auction management engine, which places each message in a LIFO queue for validation, auditing, and database entry. Finally, depending on how a security is being traded, e.g., spread, beem, dim, price, the auction management engine will automatically recalculate prices from spreads, spreads from prices, and send them along to the Bid Ladder for display.

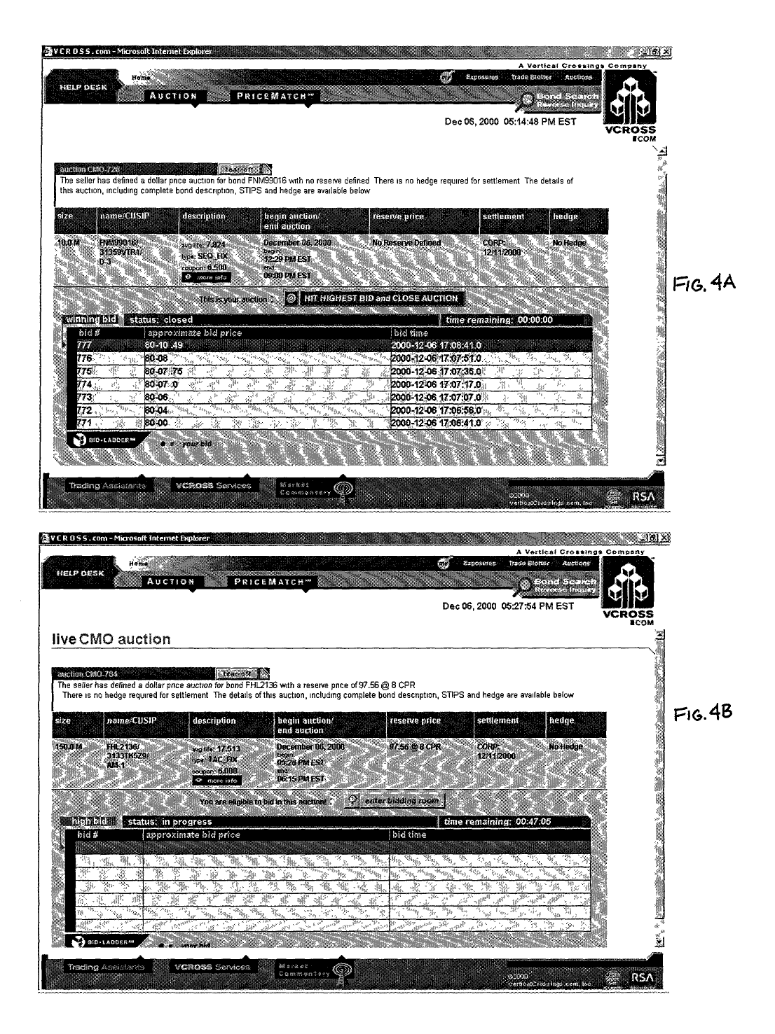

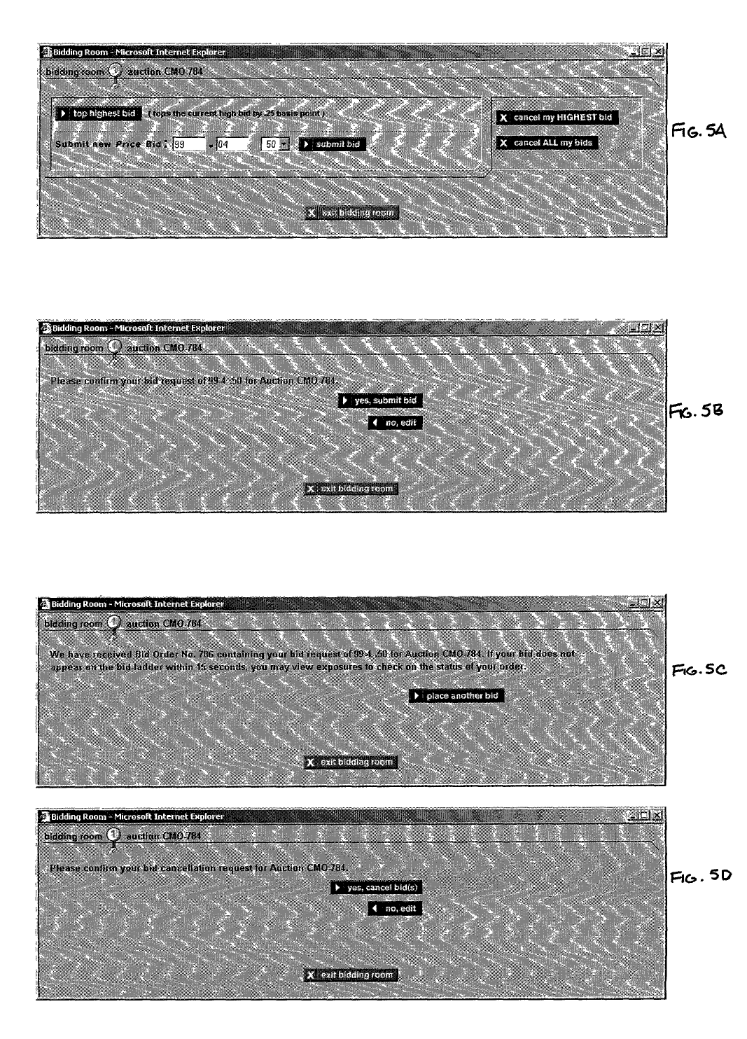

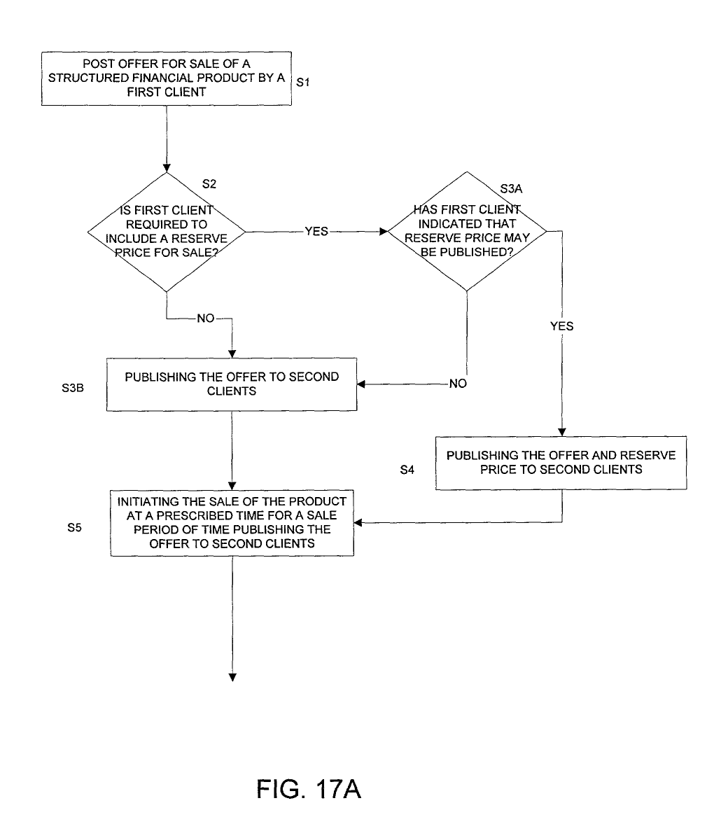

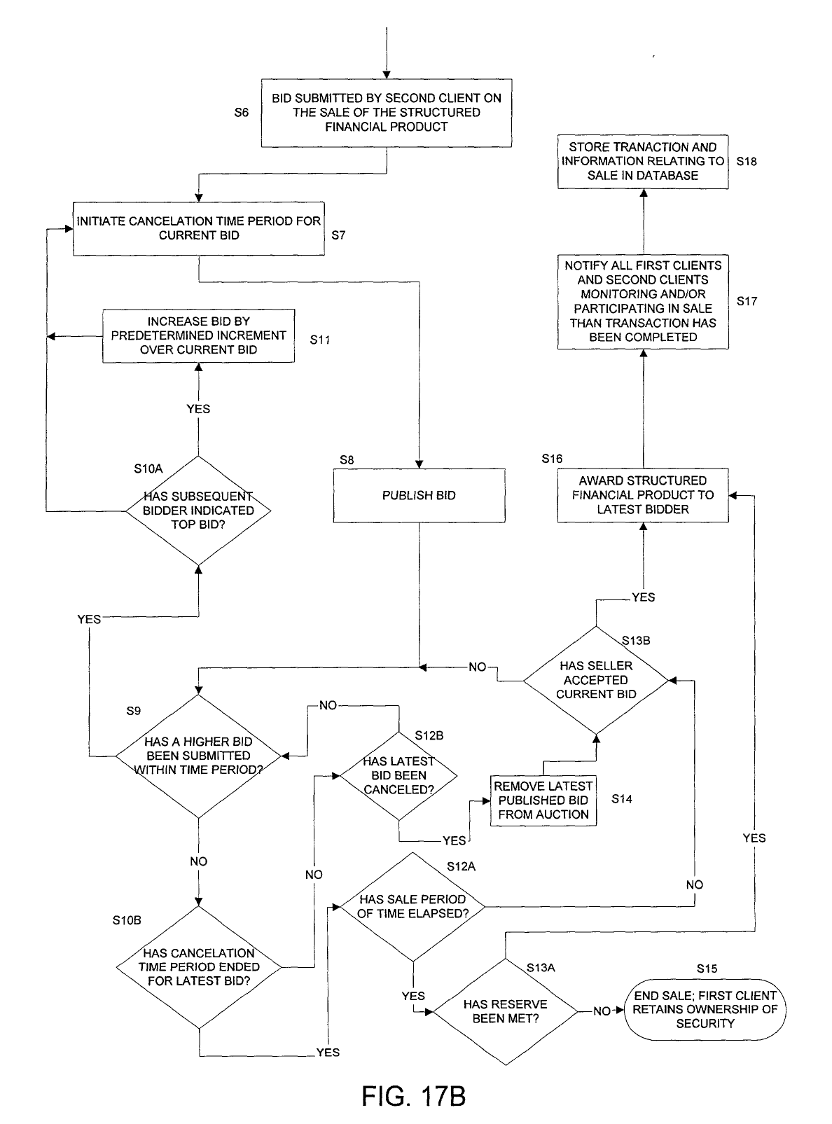

An overview of the process is illustrated in FIGS. 17A and 17B, which is associated with screen shots shown in FIG. 4B through FIG. 6. As shown, when a seller registered with the present system wishes to sell a security (preferably a structured financial product), the system posts the offer for registered users of the system to see (i.e., buyers and other sellers). The posting includes information relating to the type of security that is being sold and the starting time (and date) of the auction (S1). If the seller is required to set a reserve price, the seller may chose to have the reserve price published with the offer and/or displayed during the auction (S2-S5).

When the auction begins, a buyer may submit a bid for the purchase of the security (S6). At that time, a cancellation clock is initiated (S7), which allows the user to withdraw the bid within a predetermined time period (withdrawal period) (S12B). Although this time period may be any set value, it is preferably less than one-minute, and most preferably less than ten seconds. Preferably, at the same time or shortly thereafter, the bid is published to interested buyers and other users of the system (S8).

Upon publication of the bid, other buyers may submit bids (S9). A subsequent bid submitted by another buyer may use a top bid feature (i.e., by clicking on an appropriate icon; S10A). The top bid feature allows the subsequent bidder to place a bid incrementally larger than the current published bid (S11). Upon submission of subsequent bids, the cancellation clock is started for the corresponding buyer (S7).

Bids are accepted throughout the allotted time period for the auction of the security. However, at any time prior to the end of the auction, the seller may accept the current bid and end the auction (S13B). If the seller accepts the current bid, the auction ends and the security is awarded to the buyer who submitted the current bid (S16). A clearing house is preferably used to settle the transaction. The transaction is published and documented for other users of the system to see (S17). Information related to the sale of the security are then stored in a database of the system (S18).

If the seller does not accept any of the bids as they are submitted, the auction proceeds over the course of the prescribed time period. At the end of the time period, the security is sold to the current bidder. However, if the current bid is less than the reserve price at the end of the auction, the security is not sold and the seller retains ownership (S13A, S15)

The following additional features may optionally be incorporated into the disclosed embodiments of the system.

Reverse Inquiry Search Engine

BondAlert

BondPricer.com

MBSDataBase

Reverse Inquiry

Reverse Inquiry is the act of inquiring about a single security or specific security type to purchase. The impetus for this type of inquiry generally begins at the investor level. An example of this type of inquiry is; an insurance company is in need of a triple “A,” or high quality asset, with a long maturity to match a long-term liability such as a life insurance policy they have written. The insurance company would then make a reverse inquiry to a broker dealer, asking the dealer to offer all bonds fitting this profile.

Right away, the first problem in this system is that given there are thousands of investors and dealers that might hold these securities, how does one quickly find these bonds, and the holders? The second major problem is that in the process of calling around to find these securities, other dealers and investors may decide that they too want to buy these securities. The third problem is that when conveying buying interest in a particular security or type, competing dealers or investors may sense that the price on these securities will soon rise, and then begin to bid up the price of these securities.

As it stands today, there is no automated method or anonymous means for investors to make their buying intentions known without compromising their position in the market. There is a tremendous need to protect buy-side anonymity in reverse inquiry situations. Otherwise other market participants will continue to use this sensitive market information against the buy-side investor, as is the practice today. A further embodiment of the system includes a Reverse Inquiry Engine to combat exactly this problem.

By filling out a reverse inquiry matrix with a few mouse clicks on the auction host's website, an interested buyer can signal interest in a particular security, or across certain types of securities without identifying himself and remaining completely anonymous. This information is used to populate a central “temperature gauge” that groups together the interested buyer's interest with all other system users' interests. This data is then published to the system's optional Reverse Inquiry Temperature Gauge. This live graphical gauge/matrix allows users to quickly gauge overall market strength by maturity, security sector, and security type in seconds.

Potential sellers of securities use this graphical gauge of market strength to sell bonds from their portfolio into these pockets of market strength. Any user wishing to sell bonds into the buying interest on the Reverse Inquiry Matrix simply clicks on the appropriate strength icon and fills out a quick Bond Alert memo. The system's Reverse Inquiry Engine then instantaneously and cross-references this information and sends an anonymous Bond Alert to the appropriate buyer. In this manner, the system's Reverse Inquiry Engine matches up both buyers and sellers interests and maintains complete anonymity for both parties involved.

The system's Reverse Inquiry Engine and electronic buying interest temperature gauge streamline the antiquated and inefficient trial and error telephone chain system of today. This automation of an old procedure will result in increased market liquidity and complete investor anonymity.

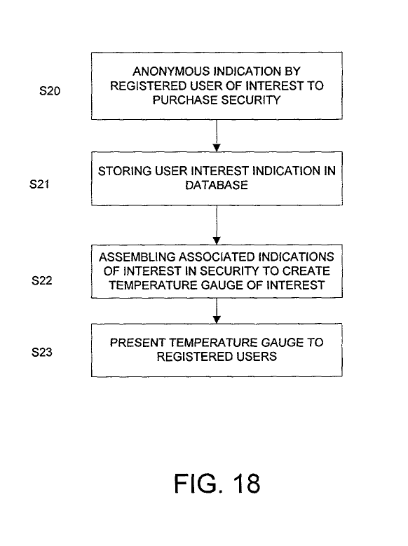

An overview of the process is illustrated in FIG. 18. Accordingly, anonymous indications by buyers of securities of interests in purchasing certain securities are registered and stored on a database (S20-S21). The interests of all buyers are then assembled to create a temperature gauge of the interest in respective securities (S22). The temperature gauge for the particular type of security is then displayed to registered users of the system (S23) giving them a gauge at which to determine the market for that particular security type.

Thus a seller who has a “hot” temperature security to sell may select a the security type from the gauge and register his security for auctioning. Thereafter, the buyers who have expressed interest in buying that type of security are notified of the impending sale (S24) via Bond Alert.

Bond alert is an automated means of communication and notification to interested buyers of certain securities, that such securities are being offered for sale. Every user on the trading system has a unique user profile of preferences. In addition, users may from time to time register new desires for particular securities with the system. When the particular bond or security becomes available, the user is notified, i.e. fax, phone, e-mail, or Live Person (similar to instant messenger technology), etc.

BondPricer

The system can also provide the option of a free pricing service to its entire user base. Users then have the option of uploading their security portfolios into the system. The system will then continuously re-price and value the security positions in the portfolios based upon the transaction history from the auction host's e-marketplace. It can also utilize a sophisticated pricing matrix to value those securities that are not currently being traded on the system.

This free service will in turn create a large universe of bonds that can be tracked and cross-referenced to the Reverse Inquiry Search Engine to facilitate liquidity. Anytime a bond is submitted for an auction or PriceMatch, holders of said securities can also be electronically notified of a pending transaction in the security they happen to own. There is no better information for a portfolio manager than this type of timely, accurate, specific data regarding their holdings. This service is long overdue for automation within the financial services community, is accomplished by the disclosed system, and in so doing also increases market liquidity.

MBSDataBase

This is a database, or library of transaction results from each and every auction and PriceMatch on the auction host's site. This data will be stored, along with a snapshot of the various market conditions under which the transaction took place, such as: the time the transaction took place, the cover bid, (second best bid), where the underlying benchmarks were trading (such as U.S. Treasuries, Interest Rate Swaps, U.S. Agencies, Libor, Euro Dollar Futures, volatility, etc.). All of this transaction data can be archived and made readily available for research purposes to all users, with the exception of the counterparty information of who purchased and sold the securities.

This searchable transactional database will increase market transparency in the fixed income marketplace. All of this information can be taken directly from the system's Bid Ladder and PriceMatch products at that moment the transaction occurs and stored into the MBSDataBase.

This library of information is invaluable to market participants because it establishes an unbiased level from which to judge where to buy or sell securities. There is no single public central repository of transaction data anywhere like this today. For example, this library will enable dealers and investors coming back from vacation to quickly scan trades that took place while out of the office, and immediately know exactly what happened. All of the trade data will also be completely unbiased and reliable, as opposed to today where traders either don't reveal trades done, or reveal slightly different levels from where trades actually took place in order to shade the market to appear stronger or weaker to suit their own agendas.

Information from the system's MBSDataBase library can be used as the reference base for the Bond Pricer feature. This pricing engine will, over time, become the most accurate structured product portfolio valuation pricing service, because it will be completely unbiased, and based upon a database of actual live transactions. Today, all pricing sources are subjective and biased because they require human input of variables. Overtime, the auction host can become an unbiased public infomediary to the entire financial services community, in stark contrast to the inherent proprietary forces and nature of the brokerage community and its operations of today.

Having described the invention with reference to the presently preferred embodiments, it should be understood that numerous changes in creating and operating such a system may be introduced without departing from the true spirit of the invention as defined in the appended claims.

What is claimed is:

1. A method for anonymously buying and selling a structured financial product over a computer network, comprising:
providing a host for receiving information for the offer for sale of a structured financial product from a first client;
anonymously publishing the offer for sale of said structured financial product over a computer network by said host to a plurality of second clients over said computer network for a predetermined period of time;
initiating said offer for sale of said product over said network at a prescribed starting time,
providing an opportunity for said plurality of second clients to bid on said product in real-time during said period of time;
automatically publishing to said plurality of second clients viewing the sale of said product each bid in real-time as each bid is submitted by one of said second clients, wherein a substantial number of all submitted bids are displayed together during said offer for sale; and
awarding said structured financial product to a second client of said plurality of said second clients submitting the highest bid by the end of said predetermined period of time.

2. The method according to claim 1, wherein said substantial number is a predetermined maximum amount.

3. The method according to claim 1, wherein said substantial number is between three and a total number of all submitted bids.

4. The method according to claim 1, wherein said substantial number is between three and ten submitted bids.

5. The method according to claim 1, wherein said substantial number is approximately seven bids.

6. The method according to claim 1, wherein said first client closes said auction

7. The method according to claim 2, wherein when submitted bids reach said predetermined maximum amount, an oldest submitted bid is no longer displayed when a newly submitted bid is displayed.

8. The method according to claim 1, wherein each successive bid is higher than the previous bid.

9. The method according to claim 1, wherein the highest bid is always displayed at the top of a column of previous lower bids.

10. The method according to claim 1, wherein said bids are placed in a column in ascending order, with the highest bid at the top of the column.

11. The method according to claim 1, wherein said bids are placed in a column in descending order, with the highest bid placed at the bottom of the column.

12. The method according to claim 1, further comprising displaying live market data concurrently during said auction.

13. The method according to claim 1, wherein said structured financial product is sold on a spread basis.

14. The method according to claim 1, wherein said structured financial product is sold on a price basis.

15. The method according to claim 13, wherein said sale of said structure financial product is published with an underlying benchmark yield.

16. The method according to claim 14, wherein the underlying benchmark yield is calculated and published after each submitted bid.

17. The method according to claim 15, wherein an all-in yield for said structured financial product is calculated and a price that reflects the spread bid is then published.

18. The method according to claim 1, wherein said predetermined period of time is between approximately fifteen seconds and approximately two minutes.

19. The method according to claim 1, wherein said predetermined period of time is between approximately thirty seconds and approximately one minute.

20. The method according to claim 1, wherein said predetermined period of time is approximately forty-five seconds.

21. The method according to claim 1, wherein each bid is published with a time that it was submitted to the auction.

22. The method according to claim 1, wherein said host receives bids over a plurality of timed increments.

23. The method according to claim 21, wherein each said increment is between approximately 0.00001 second and approximately 1 second.

24. The method according to claim 21, wherein each said increment is approximately 0.001 second.

25. The method according to claim 1, wherein a submitted bid may canceled within a predetermined cancellation period.

26. The method according to claim 24, wherein said predetermined cancellation period is less than one minute.

27. The method according to claim 24, wherein said predetermined cancellation period is less then thirty seconds.

28. The method according to claim 24, wherein said predetermined cancellation period is less than fifteen seconds.

29. The method according to claim 24, wherein said predetermined cancellation period is approximately ten seconds.

30. The method according to claim 1, wherein said first client submits a reserve price for the sale of said structured financial product.

31. The method according to claim 1, wherein said first client submits a reserve spread for the sale of said structured financial product.

32. The method according to claim 29, wherein said reserve price is published to said plurality of second clients.

33. The method according to claim 30, wherein said reserve spread is published to said plurality of second clients.

34. The method according to claim 29, wherein said reserve price remains confidential between said first client and said host.

35. The method according to claim 30, wherein said reserve spread remains confidential between said first client and said host.

36. The method according to claim 1, wherein a bid submitted by a second client is automatically increased over the current bid by a predetermined increment.

37. The method according to claim 35, wherein said predetermined increment comprises approximately one-quarter of one thirty-second in price.

38. The method according to claim 35, wherein said predetermined increment comprises approximately one-quarter of a basis point in a spread auction.

39. A system for anonymously auctioning a structured financial product over a computer network, comprising:
a computer network;
a first client in communication with said network;
a plurality of second clients in communication with said network;
a host in communication with said computer network, said host for:
receiving information for the sale of a structured financial product from said first client, and
anonymously publishing the sale of said structured financial product to said plurality of second clients and for automatically publishing to said plurality of second clients bids received for the sale of said product, wherein
said sale is initiated at a predetermined time and conducted over a predetermined period of time,
each bid is automatically published as it is received in real-time without input by said plurality of second clients,
a substantial number of all submitted bids are displayed together during said sale; and
said financial product is sold to a second client of said plurality of said second clients submitting the highest bid at the end of said predetermined time period.

40. A computer readable media including computer code comprising instructions for performing a method for anonymously buying and selling a structured financial product over a computer network, said method comprising:
providing a host for receiving information for the offer for sale of a structured financial product from a first client;
anonymously publishing the offer for sale of said structured financial product over a computer network by said host to a plurality of second clients over said computer network for a predetermined period of time;
initiating said offer for sale of said product over said network at a prescribed starting time,
providing an opportunity for said plurality of second clients to bid on said product in real-time during said period of time;
automatically publishing to said plurality of second clients viewing the sale of said product each bid in real-time as each bid is submitted by one of said second clients, wherein a substantial number of all submitted bids are displayed together during said offer for sale; and
awarding said structured financial product to a second client of said plurality of said second clients submitting the highest bid by the end of said predetermined period of time.

41. A computer system comprising:
storage means for storing data; and
a processor programmed to preform a method for buying and selling a structured financial product over a computer network, said method comprising:
providing a host for receiving information for the offer for sale of a structured financial product from a first client;
anonymously publishing the offer for sale of said structured financial product over a computer network by said host to a plurality of second clients over said computer network for a predetermined period of time;
initiating said offer for sale of said product over said network at a prescribed starting time,
providing an opportunity for said plurality of second clients to bid on said product in real-time during said period of time;
automatically publishing to said plurality of second clients viewing the sale of said product each bid in real-time as each bid is submitted by one of said second clients, wherein a substantial number of all submitted bids are displayed together during said offer for sale; and
awarding said structured financial product to a second client of said plurality of said second clients submitting the highest bid by the end of said predetermined period of time.

42. A method of realizing an interest in the sale of a structured financial product comprising:
providing a host in communication with a computer network, said host for storing a plurality of structured financial products offered for sale by a plurality of respective first clients in communication with said host in a first database;
displaying at least one field to a second client in communication with said computer network for entering a query term for searching said first database;
searching said first database with said query, wherein:
said query includes a first term for finding specific structured financial products of said plurality of structured financial products,
said second client anonymously searches said database using said query;
displaying a result of said query, wherein said result comprises at least one structured financial product;
anonymously indicating by said second client an interest in purchasing at least one structured financial product;
storing said interest of said structured financial product in said first database;
determining an interest gauge for said structured financial product based upon said interest by said second client.

43. The method according to claim 42, wherein said interest gauge is displayed with said result for subsequent second client searches.

44. The method according to claim 42, wherein said second client indicates an interest in a plurality of specific structured financial products.

45. The method according to claim 42, wherein said interest gauge is displayed to second clients upon displaying a result of a search.

46. The method according to claim 42, wherein said interest gauge is displayed to other second clients subsequent to said second client indicating said interest.

47. A method of alerting a second client of the sale of a structured financial product comprising:
providing a host in communication with a computer network, said host for
storing a plurality of structured financial products offered for sale by a plurality of respective first clients in communication with said host in a first database,
registering a second client with a second database, said registration including information relating to interest of said second client in purchasing a particular structured financial product; and
notifying said second client when said particular structured financial product is offered for sale by a first client.

48. The method according to claim 47, wherein said notifying comprises an email to said second client.

49. The method according to claim 47, wherein said notifying comprises a phone call to said second client.

50. The method according to claim 47, wherein said notifying comprises a letter to said second client.

51. A system of alerting a second client of the sale of a structured financial product comprising:
a host in communication with a computer network, said host including:
storing means for storing a plurality of structured financial products offered for sale by a plurality of respective first clients in communication with said host in a first database,
registering means for registering a second client in communication with said network with a second database, said registration including information relating to interest of said second client in purchasing a particular structured financial product;
notifying means for notifying said second client when said particular structured financial product is offered for sale by a first client.

52. A Computer readable medium having computer-executable instructions for performing a method of alerting a second client of the sale of a structured financial product, said method comprising:
providing a host in communication with a computer network, said host for
storing a plurality of structured financial products offered for sale by a plurality of respective first clients in communication with said host in a first database,
registering a second client with a second database, said registration including information relating to interest of said second client in purchasing a particular structured financial product;
notifying said second client when said particular structured financial product is offered for sale by a first client.

53. A method of tracking a structured financial product comprising:
providing a host in communication with a computer network, said host for
storing a plurality of structured financial products offered for sale by a plurality of respective first clients in communication with said host in a first database, and
buying and selling said plurality of structured financial products;
registering a second client in communication with said network in a second database so that said second client can bid on said structured financial products offered for sale, said registration including uploading portfolio information comprising current security positions in structured financial products of said second client,
valuating said security positions based upon transaction history of the sale of structured financial products from said host.

54. The method according to claim 53, wherein said valuating comprising re-pricing said security positions.

55. The method according to claim 53, further comprising notifying said second client when a structured financial product in which said second client owns a security positions is offered for sale.

56. The method according to claim 53, wherein said transaction history comprises data representing a market condition at the time of sale of said structured financial product.

57. The method according to claim 53, wherein said market condition comprises at least one of a transaction time, a cover bid, and underlying financial benchmarks.

58. The method according to claim 57, wherein said underlying financial benchmarks include U.S. Treasury information, interest rates, currency exchange, unemployment, and market volatility.

59. A system for tracking a structured financial product comprising:
a host in communication with a computer network, said host including:
storing means for storing a plurality of structured financial products offered for sale by a plurality of respective first clients in communication with said host in a first database, and
buying and selling means for buying and selling said plurality of structured financial products;
registering means for registering a second client in communication with said network in a second database so that said second client can bid on said structured financial products offered for sale, said registration including uploading portfolio information comprising current security positions in structured financial products of said second client,
valuating means for valuating said security positions based upon transaction history of the sale of structured financial products from said host.

60. A computer readable medium having computer executable instructions for performing a method of tracking a structured financial product comprising:
providing a host in communication with a computer network, said host for
storing a plurality of structured financial products offered for sale by a plurality of respective first clients in communication with said host in a first database, and
buying and selling said plurality of structured financial products;
registering a second client in communication with said network in a second database so that said second client can bid on said structured financial products offered for sale, said registration including uploading portfolio information comprising current security positions in structured financial products of said second client,
valuating said security positions based upon transaction history of the sale of structured financial products from said host.

61. A computer readable medium having stored thereon a data structure comprising:
a first field containing data representing a structured financial product which has been sold; and
a second field containing data representing a market condition at the time of sale of said structured financial product.

62. A method of valuating a structured financial product comprising:
providing a host for receiving information for the offer for sale of a structured financial product from a first client;
anonymously publishing the offer for sale of said structured financial product over a computer network by said host to a plurality of second clients over said computer network for a predetermined period of time;
initiating said offer for sale of said product over said network at a prescribed starting time,
providing an opportunity for said plurality of second clients to bid on said product in real-time during said period of time;
awarding said structured financial product to a second client of said plurality of said second clients submitting the highest bid by the end of said predetermined period of time;
storing information related to the sale of said structured financial product in a first database, said information comprising first data representing the time at which said structured financial product was sold and second data representing a market condition at the time of sale of said structured financial product;
searching said database for finding particular structured financial products which have been sold;
displaying the result of said search, wherein said results include at least one structured financial product and associated said first data and said second data.
